(19) United States
(12) Patent Application Publication
(10) Pub. No.: US 2018/0321546 A1
(43) Pub. Date: Nov. 8, 2018

(54) SWITCHING MIRROR PANEL AND SWITCHING MIRROR DEVICE

(71) Applicant: SHARP KABUSHIKI KAISHA, Sakai City, Osaka (JP)

(72) Inventors: AKIRA SAKAI, Sakai City (JP); HIROYUKI HAKOI, Sakai City (JP); KIYOSHI MINOURA, Sakai City (JP)

(21) Appl. No.: 15/772,047

(22) PCT Filed: Oct. 24, 2016
(86) PCT No.: PCT/JP2016/081383

§ 371 Date: Apr. 28, 2018

(30) Foreign Application Priority Data
Oct. 30, 2015 (JP) 2015-214797

(51) Int. Cl. G02F 1/1335; G02F 1/1339

(52) U.S. Cl. CPC G02F 1/133504; G02F 1/133536; G02F 2001/1351; G02F 1/133553; G02F 1/1339

(57) ABSTRACT

The switching mirror panel of the present invention includes, in the following order: a reflective polarizing plate; a liquid crystal panel including paired facing substrates, and a liquid crystal layer and a sealing material disposed between the paired substrates; and an absorptive polarizing plate, wherein the switching mirror panel is capable of switching between a transparent mode and a mirror mode, where the transparent mode allows light to pass from the viewing surface side of the absorptive polarizing plate to the back surface side of the reflective polarizing plate and the mirror mode does not allow light to pass from the viewing surface side of the absorptive polarizing plate to the back surface side of the reflective polarizing plate, the sealing material transmits light incident from the normal direction of the absorptive polarizing plate, and the sealing material has a haze of 0% or higher and 10% or lower.

### TECHNICAL FIELD

The present invention relates to switching mirror panels and switching mirror devices. In particular, the present invention relates to a switching mirror panel capable of switching between a transparent mode in which printed articles and the like on the back surface side of the mirror panel are visible and a mirror mode in which the mirror panel functions as a mirror. The present invention also relates to a switching mirror device including the switching mirror panel.

### BACKGROUND

Mirror displays for digital signage or the like applications have been proposed which include a half mirror layer on the viewing surface side of a display device to function as a mirror (for example, see Patent Literatures 1 to 4). Such mirror displays provide images using display light emitted from the display devices and are also used as mirrors in a state of reflecting external light.

### CITATION LIST

### Patent Literature

Patent Literature 1: JP 3419766 B
Patent Literature 2: JP 2003-241175 A
Patent Literature 3: JP H11-15392 A
Patent Literature 4: JP 2004-085590 A

### SUMMARY OF INVENTION

### Technical problem

The half mirror layer is an optical member that has a reflective function. For example, the half mirror layer may be a switching mirror panel including, in the following order from the back surface side to the viewing surface side, a reflective polarizing plate, a liquid crystal panel, and an absorptive polarizing plate. Mirror displays with such a switching mirror panel are capable of switching between a mode that does not reflect external light when the display device provides images and a mode that reflects external light when the display device provides no images.

The present inventors made a study to find out that the switching mirror panels have applications other than the mirror display. Specifically, when the switching mirror panel is disposed on a poster, the switching mirror panel can switch between a transparent mode in which the poster is visible and a mirror mode in which the mirror panel functions as a mirror. Moreover, when the switching mirror panel is disposed on a cellular phone cover with a printed pattern, the switching mirror panel can switch between a transparent mode in which the printed pattern on the cover is visible and a mirror mode in which the mirror panel functions as a mirror. Thus, by disposing the switching mirror panel not on a display device but on a reflector (e.g., posters, cellular phone covers) that is a non-self-luminous body, it is possible to achieve a switching mirror device that allows a pattern on the reflector to be viewed when necessary.

Unfortunately, when the inventors actually made such a switching mirror panel, the sealing material in the liquid crystal panel constituting the switching mirror panel was visible as a shadow in both the transparent mode and the mirror mode, lowering the design characteristics. The reason for this is described below.

The liquid crystal panel includes paired facing substrates together with a liquid crystal layer and a sealing material disposed between the paired substrates. The sealing material is typically disposed on the periphery (also referred to as a frame region) of the liquid crystal panel. The sealing material appears to be opaque because the sealing material colors light white or other colors when scattering it. Additionally, in the switching mirror panel in the switching mirror device, the sealing material when viewed from the viewing surface side is not hidden by a light-shielding body such as a bezel or a housing. For these reasons, the sealing material in the transparent mode and the mirror mode is visible as a shadow.

In contrast, in a liquid crystal display device and a mirror display, the sealing material is hidden by a light-shielding body when viewed from, the viewing surface side. The sealing material is thus not visible even if it has a low transparency (a transparency greatly different from those of other parts).

Patent Literature 1 discloses a half mirror layer including, in the following order from the back surface side to the viewing surface side, a reflective polarization selecting member, a varying part for the polarization axis of transmitted light, and an absorptive polarization selecting member. Here, the varying part for the polarization axis of transmitted light is structurally capable of selecting whether or not altering, in transmission of incident linearly polarized light, the polarization state of the light into linearly polarized light whose polarization axis is perpendicular to that of the incident linearly polarized light. The invention of Patent Literature 1, however, relates to mirror displays and does not prevent the sealing material from being visible in the switching mirror panel. The inventions of Patent Literatures 2 to 4 also do not prevent the sealing material from being visible in the switching mirror panel.

The present invention was made in view of the situation in the art and aims to provide a switching mirror panel in which the sealing material is less visible and which has excellent design characteristics, and a switching mirror device including the switching mirror panel.

### Solution to Problem

The present inventors made various studies about switching mirror panels in which the sealing material is less visible and which have excellent design characteristics. They focused on enhancement of the transparency of the sealing material. They found out that adjustment of the haze of the sealing material within a predetermined range makes the sealing material less visible even when the sealing material viewed from the viewing surface side is not hidden by a light-shielding body. The inventors thus arrived at a solution to the above problem, completing the present invention.

One aspect of the present invention may be a switching mirror panel including, in the following order from the back surface side to the viewing surface side: a reflective polarizing plate; a liquid crystal panel including paired facing substrates, and a liquid crystal layer and a sealing material disposed between the paired substrates; and an absorptive polarizing plate, wherein the switching mirror panel is capable of switching between a transparent mode and a mirror mode, where the transparent-mode allows light to pass from the viewing surface side of the absorptive polarizing plate to the back surface side of the reflective polarizing plate and the mirror mode does not allow light to pass from the viewing surface side of the absorptive polarizing plate to the back surface side of the reflective polarizing plate, the sealing material transmits light incident from the normal direction of the absorptive polarizing plate, and the sealing material has a haze of 0% or higher and 10% or lower.

Another aspect of the present invention may be a switching mirror device, including, in the following order from the back surface side to the viewing surface side: a reflector that is a non-self-luminous body; and the switching mirror panel.

### Advantageous Effects of Invention

The present invention provides a switching mirror panel in which the sealing material is less visible and which has excellent design characteristics, and a switching mirror device including the switching mirror panel.

### BRIEF DESCRIPTION OF DRAWINGS

FIG. 1 is a schematic, cross-sectional view of a switching mirror panel and a switching mirror device of Embodiment 1.

FIG. 2 is a schematic cross-sectional view of a first configuration example of a reflector.

FIG. 3 is a schematic cross-sectional view of a second configuration example of the reflector.

FIG. 4 is a schematic cross-sectional view of a third configuration example of the reflector.

FIG. 5 is a schematic, cross-sectional view of a fourth configuration example of the reflector.

FIG. 6 is a schematic cross-sectional view of a switching mirror panel and a switching mirror device of Embodiment 2.

### DESCRIPTION OF EMBODIMENTS

The present invention is described below in more detail based on embodiments with reference to the drawings. The embodiments, however, are not intended to limit the scope of the present invention. In the following description, the same portions or portions having a similar function will be commonly indicated by the same reference sign in different drawings, and will not be repeatedly described. The configurations employed in the embodiments may appropriately be combined or modified within the spirit of the present invention.

### Embodiment 1

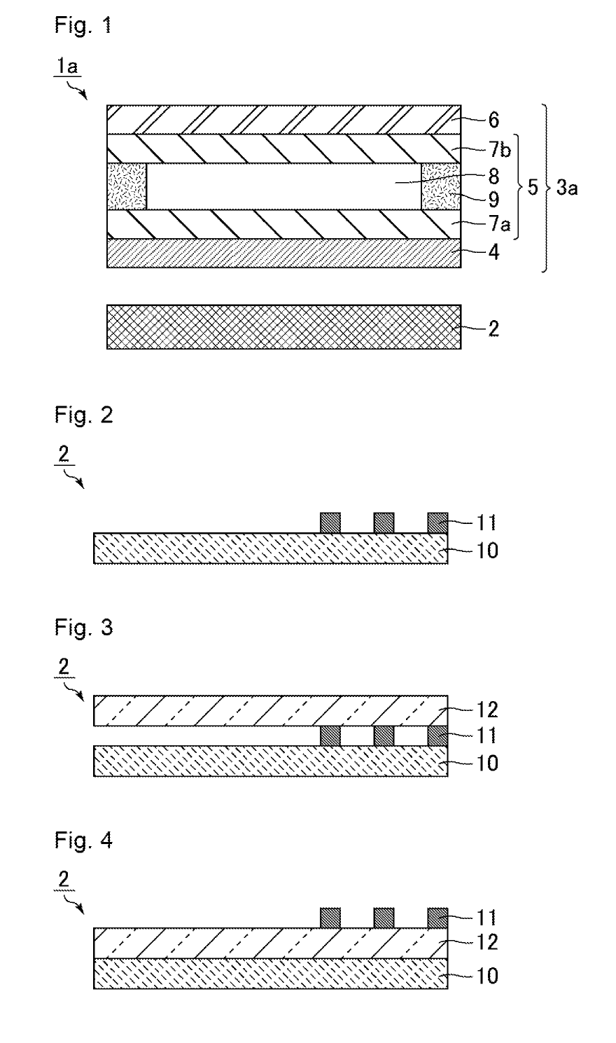

A switching mirror panel and a switching mirror device of Embodiment 1 will be described below with reference to FIG. 1. FIG. 1 is a schematic cross-sectional view of the switching mirror panel and the switching mirror device of Embodiment 1.

A switching mirror device 1a includes, in the following order from the back surface side to the viewing surface side, a reflector 2 and a switching mirror panel 3a. Although the reflector 2 and the switching mirror panel 3a are separate in FIG. 1, they may be bonded via, for example, a pressure-sensitive adhesive. Alternatively, the switching mirror panel 3a may be directly disposed on the reflector 2. The back surface side herein refers to, in FIG. 1, for example, the bottom side of the switching mirror device 1a (bottom side of the switching mirror panel 3a). The viewing surface side herein refers to, in FIG. 1, for example, the top side of the switching mirror device 1a (top side of the switching mirror panel 3a).

The reflector 2 is a non-self-luminous body. The non-self-luminous body herein refers to a body that does not emit light by itself (e.g., posters, photographs), and is not a body that emits light by itself such as a display panel (e.g., liquid crystal display panels, organic electroluminescent display panels). The reflectance of the reflector 2 is not zero. The reflectance herein refers to luminous reflectance, unless otherwise specified.

The switching mirror panel 3a includes, in the following order from the back surface side to the viewing surface side, a reflective polarizing plate 4, a liquid crystal panel 5, and an absorptive polarizing plate 6. The reflective polarizing plate 4 may be bonded to the back surface side of the liquid crystal panel 5 via a pressure-sensitive adhesive or the like. The absorptive polarizing plate 6 may be bonded to the viewing surface side of the liquid crystal panel 5 via a pressure-sensitive adhesive or the like.

The reflective polarizing plate 4 may be, for example, a multilayer reflective polarizing plate, a nano-wire grid polarizing plate, or a reflective polarizing plate that utilizes selective reflection of cholesteric liquid crystal. Examples of the multilayer reflective polarizing plate include a reflective polarizing plate (trade name: DBEF) available from Sumitomo 3M Ltd. Examples of the reflective polarizing plate that utilizes selective reflection of cholesteric liquid crystal include a reflective polarizing plate (trade name: PCF) available from Nitto Denko Corporation. The reflectance and transmittance of the reflective polarizing plate 4 are not particularly limited, and may be adjusted, as desired by stacking two or more reflective polarizing plates on each other with their transmission axes shifted from each other.

The liquid crystal panel 5 includes a substrate 7a, a substrate 7b facing the substrate 7a, and a liquid crystal layer 8 and a sealing material 9 disposed, between the substrates. The substrate 7a and the substrate 7b are bonded together via the sealing material 9, with the liquid crystal layer 8 interposed between the substrates 7a and 7b. The sealing material 9 is disposed on the periphery of the liquid crystal panel 5.

The substrate 7a and the substrate 7b each may have a structure in which an alignment film that controls the alignment of the liquid crystal molecules in the liquid crystal layer 8, a transparent electrode, and other component (s) are appropriately disposed, on a transparent substrate.

Examples of the transparent substrate include glass substrates and plastic substrates. When a plastic substrate is used as the transparent substrate, the switching mirror panel 3a can be flexible.

The alignment film may be one produced by a conventionally known method.

The transparent electrode may be, for example, a planar (solid) electrode, a matrix electrode, or a segment electrode, and those produced by conventionally known methods can be used. In the liquid crystal panel 5, it is sufficient that the alignment of the liquid crystal molecules in the liquid crystal layer 8 can be at least wholly and collectively controlled. Thus, it is not always necessary to divide the liquid crystal panel 5 into multiple pixels with a matrix electrode or a segment electrode, or to dispose thin film transistor elements to separately drive the individual pixels. When it is desired to partially control the alignment of the liquid crystal molecules in the liquid crystal layer 8, the function of such control may be given to the substrate 7a and the substrate 7b by any conventionally known technique (e.g., a matrix electrode, a segment electrode, thin film transistor elements).

When thin film transistor elements are formed on the substrate 7a and substrate 7b, the semiconductor layer of the thin film transistor elements may have any structure. For example, the semiconductor layer may include amorphous silicon, low-temperature polysilicon, or oxide semiconductor. Examples of the oxide semiconductor include compounds containing indium., gallium, zinc, and oxygen and compounds containing indium, zinc, and oxygen. In the case of using as the oxide semiconductor a compound containing indium, gallium, zinc, and oxygen which has a low off-leakage current, application of voltage to the oxide semiconductor enables paused drive in which the voltage is held until the next data signal (voltage) is input (applied). A compound containing indium, gallium, zinc, and oxygen is therefore preferred as the oxide semiconductor in terms of low power consumption.

Since the function of the switching mirror panel 3a is to switch between the transparent mode and the mirror mode, it is not necessary to dispose color filter layers on the substrate 7a and the substrate 7b. It is also not necessary to dispose a backlight.

The sealing material 9 when viewed from the viewing surface side is not hidden by a light-shielding body such as a bezel or a housing. That is, light incident from the normal direction of the absorptive polarizing plate 6 can pass through the sealing material 9. For enhanced design characteristics, the switching mirror panel 3a preferably has no light-shielding body such as a bezel or a housing, even in a position where the light-shielding body will not hide the sealing material 9 when viewed from the viewing surface side.

The sealing material 9 has a haze of 0% or higher and 10% or lower, preferably 0% or higher and 7% or lower, more preferably 0% or higher and 5% or lower. When the sealing material 9 has a haze of 10% or lower, the sealing material 9 has high transparency and thus is less visible. As a result, the switching mirror panel 3a can achieve excellent design characteristics. The haze of the sealing material herein refers to a measured value of the haze of the sealing material alone based on its actual thickness and state (cured state) in the switching mirror panel. The haze is measured using, for example, a haze meter (trade name: NDH2000) available from Nippon Denshoku Industries Co., Ltd. The haze of the sealing material 9 is not a physical property determined uniquely by the type of the material, but a physical property determined by the actual thickness and conditions of the sealing material 9 in the switching mirror panel 3a. The thickness of the sealing material 9 is the length in the direction perpendicular to the liquid crystal layer 8 side surface of the substrate 7a (7b).

Examples of the sealing material 9 with a haze in the above range include the following sealing materials (1) to (3).

### (1) Sealing Material Containing Binder and Spacers

The sealing material (1) can be obtained by mixing a highly-transparent binder and spacers that have a similar refractive index. The spacers are used for maintaining the cell gap (distance between the substrate 7a and the substrate 7b : the thickness of the liquid crystal layer 8) in the liquid crystal panel 5. Examples of the combination of such materials include a combination of a polyene-polythiol resin composition (binder) and micro glass beads (spacers).

The difference in refractive index between the binder and the spacers is preferably 0 or greater and 0.05 or smaller, more preferably 0 or greater and 0.03 or smaller. When the difference in refractive index between the binder and the spacers is 0.05 or smaller, the sealing material 9 has a sufficiently high transparency and is less visible.

The haze of the sealing material 9 can be changed by adjusting the amount of the spacers therein. Although depending on the material of the spacers, the amount of the spacers in the sealing material 9 is preferably 0.5% by weight or less, more preferably 0.2% by weight or less. The sealing material 9 containing 0.5% by weight or less of the spacers has a sufficiently high transparency and is less visible even if the difference in refractive index between the binder and the spacers is greater than 0.05.

### (2) Sealing Material Containing no Spacers

The sealing material (2) can be obtained by not adding spacers to the sealing material (1). In this case, the cell gap in the liquid crystal panel 5 can be maintained by spreading spacers (e.g., micro glass beads) in the liquid crystal layer 8. In the case of using the sealing material (2), the cell gap in the liquid crystal panel 5 may be less uniform than in the case of using the sealing material (1). However, since the function of the switching mirror panel 3a is to switch between the transparent mode and the mirror mode, variation in properties due to the non-uniform, cell gap in the liquid crystal panel 5 will not cause problems in actual use.

### (3) Sealing Material Containing Glass Frit

The sealing material (3) can be obtained using low-melting glass-frit containing paste. The glass frit may be mixed with powder of lead oxide (PbO), zinc oxide (ZnO), silicon dioxide (SiO₂), or barium oxide (BaO) to decrease the melting point and thereby facilitate bonding. Even in such a case, the glass frit is primarily made of glass, so that it has a low haze and is transparent like glass.

The liquid crystal alignment mode of the liquid crystal panel 5 may be, but is not particularly limited to, a twisted nematic (TN) mode, a vertical alignment (VA) mode, an in-plane switching (IPS) mode, a fringe field switching (FFS) mode, or am electrically controlled birefringence (ECB) mode.

For example, the TN mode is a liquid crystal alignment mode in which when voltage is applied, the liquid crystal molecules aligned, with a 90° twist between and parallel to paired substrates shift in the direction perpendicular to the substrates surfaces, thereby changing the amount of transmitted light. In the TN mode liquid crystal panel with no voltage applied, linearly polarized light incident on the liquid crystal panel travels along the twisted liquid crystal molecules, eventually demonstrating a 90° azimuth rotation. This phenomenon is called optical rotation. That is, the TN mode is a liquid crystal alignment mode that utilizes optical rotation (hereinafter, this mode is also referred to as an optical rotation mode). When sufficient voltage is applied, the twisted configuration is broken as the liquid crystal molecules shift in the direction perpendicular to the substrate surfaces, so that the optical rotation is lost.

Unlike the TN mode described above, the VA mode, IPS mode, FFS mode, and ECB mode are not optical rotation modes, but liquid crystal alignment modes that utilize the birefringence of liquid crystal molecules (hereinafter these modes are also referred to as birefringence modes). The birefringence mode is a mode in which variable voltage is applied to the liquid crystal molecules so that the retardation is changed. In the birefringence mode liquid crystal panel, the birefringence in the liquid crystal panel alters the polarization state of linearly polarized light incident on the liquid crystal panel, usually to convert the light into elliptically polarized light having an ellipticity corresponding to the retardation.

For example, in the VA mode liquid crystal panel, when no voltage is applied, liquid crystal molecules having negative anisotropy of dielectric constant between the paired substrates are aligned perpendicularly to the substrate surfaces. As the VA mode liquid crystal panel has a retardation of zero when no voltage is applied, the VA mode liquid crystal panel transmits linearly polarized light incident on the liquid crystal panel without altering the polarization state. Application of voltage gradually tilts the liquid crystal molecules in the direction parallel to the substrate surfaces, thereby gradually increasing the retardation.

In the ECB mode liquid crystal panel, for example, when no voltage is applied, liquid crystal molecules between the paired substrates are aligned parallel to the substrate surfaces. As the ECB mode liquid crystal panel has a retardation of not zero when no voltage is applied, the ECB mode liquid crystal panel alters, in transmitting linearly polarized light incident on the liquid crystal panel, the polarized state of the light. Application of voltage gradually tilts the liquid crystal molecules in the direction perpendicular to the substrate surfaces, so that the birefringence is lost, that is, the retardation becomes zero.

The absorptive polarizing plate 6 may be, for example, a plate obtained by adsorption alignment of a dichroic anisotropic material, such as an iodine complex, on a polyvinyl alcohol (PVA) film. The absorptive polarizing plate has a function of absorbing incident polarized light vibrating at an azimuth parallel to its absorption axis and transmits incident polarized light vibrating at an azimuth parallel to its transmission axis perpendicular to the absorption axis.

The absorptive polarizing plate 6 preferably has a parallel transmittance of 37% or higher and 50% or lower, more preferably 37% or higher and 43% or lower, still more preferably 37% or higher and 40% or lower, particularly preferably 38% or higher and 39% or lower. When the absorptive polarizing plate 6 has a parallel transmittance of 37% or higher, the switching mirror panel 3a in the transparent mode has a sufficiently improved transparency. This results in a sufficiently improved visibility of the reflector 2 in the transparent mode. From the viewpoint of sufficiently improving the transparency of the switching mirror panel 3a in the transparent mode, the absorptive polarizing plate 6 preferably has a high parallel transmittance. However, the absorptive polarizing plate 6 with too high a parallel transmittance exhibits a low degree of polarization. With such an absorptive polarizing plate, the performance of the switching mirror panel 3a (the function of switching between the transparent mode and the mirror mode) may be insufficient.

The relationship between the transmission axis of the reflective polarizing plate 4 and the transmission axis of the absorptive polarizing plate 6 may be appropriately determined according to the liquid crystal alignment mode of the liquid crystal panel 5. From the viewpoint of achieving both the visibility of the reflector 2 in the transparent mode and the visibility of mirror images in the mirror mode, the transmission axis of the reflective polarizing plate 4 and the transmission axis of the absorptive polarizing plate 6 are preferably parallel or perpendicular to each other. The expression that “two transmission axes are parallel to each other” herein means that the angle formed by the transmission axes is within the range of 0±3°, preferably in the range of 0±1°, more preferably in the range of 0±0.5°, particularly preferably 0° (perfectly parallel to each other). The expression that “two transmission axes are perpendicular to each other” herein means that the angle formed by the transmission axes is within the range of 90±3°, preferably in the range of 90±1°, more preferably in the range of 90±0.5°, particularly preferably 90° (perfectly perpendicular to each other).

The switching mirror panel 3a is capable of switching between the transparent mode and the mirror mode by the following mechanism. The transparent mode is the state where light can pass from the viewing surface side of the absorptive polarizing plate 6 to the back surface side of the reflective polarizing plate 4. The mirror mode is the state where light cannot pass from the viewing surface side of the absorptive polarizing plate 6 to the back surface side of the reflective polarizing plate 4. The following will describe the case (A) where the transmission axis of the reflective polarizing plate 4 and the transmission axis of the absorptive polarizing plate 6 are parallel to each other and the case (B) where the transmission axis of the reflective polarizing plate 4 and the transmission axis of the absorptive polarizing plate 6 are perpendicular to each other.

First, the case (A) where the transmission axis of the reflective polarizing plate 4 and the transmission axis of the absorptive polarizing plate 6 are parallel to each other will be described.

### (Transparent Mode: Case (A))

The transparent mode in the TN mode liquid crystal panel, for example, is achieved in the state where voltage is applied (the state where enough voltage is applied for optical rotation to be lost). This will be specifically described below.

First, light incident on the absorptive polarizing plate 6 from the viewing surface side that vibrates at an azimuth parallel to the transmission axis of the absorptive polarizing plate 6 passes through the absorptive polarizing plate 6 to be converted into linearly polarized light. The linearly polarized light emerging from the absorptive polarizing plate 6 passes through the liquid crystal panel 5 (with voltage applied) without changing the azimuth. The linearly polarized light having passed through the liquid crystal panel 5 passes through the reflective polarizing plate 4, whose transmission axis is parallel to the transmission axis of the absorptive polarizing plate 6. The linearly polarized light emerging from the reflective polarizing plate 4 is then reflected by the reflector 2, When the reflector 2 is a reflector that does not alter the polarization state of incident polarized light, the light reflected by the reflector 2 passes through the reflective polarizing plate 4 without changing the azimuth and with being kept in the linearly polarized state. Having passed through the reflective polarizing plate 4, the linearly polarized light passes through the liquid crystal panel 5 (with voltage applied) and the absorptive polarizing plate 6 in sequence to eventually return to the viewing surface side. Thus, in the transparent mode, the reflector 2 is visible through the switching mirror panel 3a, and a pattern that may be drawn on the reflector 2 is visible.

Light incident on the absorptive polarizing plate 6 from the viewing surface side that vibrates at an azimuth perpendicular to the transmission axis (parallel to the absorption axis) of the absorptive polarizing plate 6 is absorbed by the absorptive polarizing plate 6.

### (Mirror Mode: Case (A))

The mirror mode in the TN mode liquid crystal panel, for example, is achieved in the state where no voltage is applied (the state where enough voltage is not applied so as to provide optical rotation). This will be specifically described below.

First, light incident on the absorptive polarizing plate 6 from the viewing surface side that vibrates at an azimuth parallel to the transmission axis of the absorptive polarizing plate 6 passes through the absorptive polarizing plate 6 to be converted into linearly polarized light. The linearly polarized light emerging from the absorptive polarizing plate 6 travels along the twisted liquid crystal molecules as it passes through the liquid crystal panel 5 (with no voltage applied), thereby demonstrating 90°azimuth rotation. The light is thus converted into linearly polarized light that vibrates at an azimuth perpendicular to the transmission axis of the absorptive polarizing plate 6. The linearly polarized light having passed through the liquid crystal panel 5 is reflected by the reflective polarizing plate 4, whose reflection axis is perpendicular to the transmission axis of the absorptive polarizing plate 6. The linearly polarized light reflected by reflective polarizing plate 4 travels along the twisted liquid crystal molecules as it passes through the liquid crystal panel 5 (with no voltage applied), thereby demonstrating 90° azimuth rotation. The light is thus converted into linearly polarized light that vibrates at an azimuth parallel to the transmission axis of the absorptive polarizing plate 6. Having passed through the liquid crystal panel 5, the linearly polarized light passes through the absorptive polarizing plate 6 to eventually return to the viewing surface side. Thus, mirror images are visible in the mirror mode.

Light incident on the absorptive polarizing plate 6 from the viewing surface side that vibrates at an azimuth perpendicular to the transmission axis (parallel to the absorption axis) of the absorptive polarizing plate 6 is absorbed by the absorptive polarizing plate 6.

Next, the case (B) where the transmission axis of the reflective polarizing plate 4 and the transmission axis of the absorptive polarizing plate 6 are perpendicular to each to other will be described.

### (Transparent Mode: Case (B))

The transparent mode in the TN mode liquid crystal panel, for example, is achieved in the state where no voltage is applied (the state where enough voltage is not applied so as to provide optical rotation). This will be specifically described below.

First, light incident on the absorptive polarizing plate 6 from the viewing surface side that vibrates at an azimuth parallel to the transmission axis of the absorptive polarizing plate 6 passes through the absorptive polarizing plate 6 to be converted into linearly polarized light. The linearly polarized light emerging from the absorptive polarizing plate 6 travels along the twisted liquid crystal molecules as it passes through the liquid crystal panel 5 (with no voltage applied), thereby demonstrating 90°azimuth rotation. The light is thus converted into linearly polarized light that vibrates at an azimuth perpendicular to the transmission axis of the absorptive polarizing plate 6. The linearly polarized light having passed through the liquid crystal panel 5 passes through the reflective polarizing plate 4, whose transmission axis is perpendicular to the transmission axis of the absorptive polarizing plate 6. The linearly polarized light emerging from the reflective polarizing plate 4 is then reflected by the reflector 2. When the reflector 2 is a reflector that does not alter the polarization state of incident polarized light, the light reflected by the reflector 2 passes through the reflective polarizing plate 4 without changing the azimuth and with being kept in the linearly polarized state. The linearly polarized light emerging from the reflective polarizing plate 4 then travels along the twisted liquid crystal molecules as it passes through the liquid crystal panel 5 (with no voltage applied), thereby demonstrating 90° azimuth rotation. The light is thus converted into linearly polarized light that vibrates at an azimuth parallel to the transmission axis of the absorptive polarizing plate 6. Having passed through the liquid crystal panel 5, the linearly polarized light passes through the absorptive polarizing plate 6 to eventually return to the viewing surface side. Thus, in the transparent mode, the reflector 2 is visible through the switching mirror panel 3a, and a pattern that may be drawn on the reflector 2 is visible.

Light incident on the absorptive polarizing plate 6 from the viewing surface side that vibrates at an azimuth perpendicular to the transmission axis (parallel to the absorption axis) of the absorptive polarizing plate 6 is absorbed by the absorptive polarizing plate 6.

### (Mirror Mode: Case (B))

The mirror mode in the TN mode liquid crystal panel, for example, is achieved in the state where voltage is applied (the state where enough voltage is applied for optical rotation to be lost). This will be specifically described below.

First, light incident on the absorptive polarizing plate 6 from the viewing surface side that vibrates at an azimuth parallel to the transmission axis of the absorptive polarizing plate 6 passes through the absorptive polarizing plate 6 to be converted into linearly polarized light. The linearly polarized light emerging from the absorptive polarizing plate 6 passes through the liquid crystal panel 5 (with voltage applied) without changing the azimuth. The linearly polarized light having passed through the liquid crystal panel 5 is reflected by the reflective polarizing plate 4, whose reflection axis is parallel to the transmission axis of the absorptive polarizing plate 6. The linearly polarized light reflected by the reflective polarizing plate 4 then passes through the liquid crystal panel 5 (with voltage applied) and the absorptive polarizing plate 6 in sequence to eventually return to the viewing surface side. Thus, in the mirror mode, mirror images are visible.

Light incident on the absorptive polarizing plate 6 from the viewing surface side that vibrates at an azimuth perpendicular to the transmission axis (parallel to the absorption axis) of the absorptive polarizing plate 6 is absorbed by the absorptive polarizing plate 6.

The present inventors made a study to find out that the reflector 2 of the switching mirror device 1a can have a low visibility in the transparent mode. The present inventors investigated the reason for the low visibility and found out that the visibility of the reflector 2 in the transparent mode varies depending on whether the reflector 2 alters the polarized state of incident polarized light.

For example, in a mirror display including the switching mirror panel 3a, the polarized light emitting display device naturally emits polarized light, so that the switching mirror panel 3a transmits the polarized light without loss. In the switching mirror device 1a, linearly polarized light emerging from the switching mirror panel 3a returns to the viewing surface side without loss when the reflector 2 reflects the light without altering the polarized state. However, when the reflector 2 alters the polarized state in reflecting the light, linearly polarized light emerging from the switching mirror panel 3a fails to return to the viewing surface side without loss, decreasing the visibility of the reflector 2 in the transparent mode. Especially when the reflector 2 causes 90° azimuth rotation in reflecting the linearly polarized light emerging from the switching mirror panel 3a, the linearly polarized light reflected by the reflector 2 is reflected by the reflective polarizing plate 4, failing to return to the viewing 5 surface side. This makes the reflector 2 invisible and makes the switching mirror panel 3a opaque.

Accordingly, from the viewpoint of sufficiently improving the visibility of the reflector 2 in the transparent mode, the reflector 2 preferably includes a substrate that does not alter the polarization state of incident polarized light (hereinafter also referred to as “does not depolarize incident polarized light”). The expression “does not alter the polarization state of incident polarized light (does not depolarize incident polarized light)” herein means that the substrates give incident polarized light a retardation of 10 nm or smaller, preferably 5 nm or smaller, more preferably 3 nm or smaller, particularly preferably zero (not alter the polarized state at all).

Examples of the substrate that does not depolarize incident polarized light include mirrors, aluminum foil, and paper that exhibit regular reflection. The mirror may be, for example, a mirror obtained by depositing an aluminum layer onto the surface of a glass substrate. Aluminum foil scatters and reflects light to appear white, but hardly depolarizes incident polarized light. The paper may be common plain paper (copy paper), but is preferably surface-coated glossy paper because too many portions (pores) where no fibers exist may increase the degree of depolarization.

With reference to FIGS. 2 to 5, the following will describe configuration examples (first to fourth configuration examples) in which the reflector 2 includes a substrate that does not depolarize incident polarized light.

### FIRST CONFIGURATION EXAMPLE

FIG. 2 is a schematic cross-sectional view of a first configuration example of the reflector. The reflector 2 includes, in the following order from, the back surface side to the viewing surface side, a substrate 10 that does not depolarize incident, polarized, light, and an ink layer 11. The ink layer 11 is in direct contact with the substrate 10.

The ink layer 11 may be formed by, for example, directly drawing a pattern on the surface of the substrate 10 with an oil-based marker or by directly printing a pattern on the surface of the substrate 10 by a conventionally known method.

When the integration of the ink layer 11 and the substrate 10 is bonded to the reflective polarizing plate 4 via a pressure-sensitive adhesive or the like, bonding is affected by the unevenness of the ink layer 11. However, for example, the use of a pressure-sensitive adhesive about four or more times thicker than the ink layer 11 enables bonding to be conducted without being affected by the unevenness of the ink layer 11. Since the ink layer 11 often has a thickness of 25 μm or smaller, bonding can be conducted without problems by using a pressure-sensitive adhesive having a thickness of, for example, about 100 μm.

### SECOND CONFIGURATION EXAMPLE

FIG. 3 is a schematic cross-sectional view of a second configuration example of the reflector. The reflector 2 includes, in the following order from the back surface side to the viewing surface side, the substrate 10 that does not depolarize incident polarized light, the ink layer 11, and a non-birefringent film 12. The ink layer 11 is in direct contact with the non-birefringent film 12. The integration of the ink layer 11 and the non-birefringent film 12 may be bonded to the substrate 10 via a pressure-sensitive adhesive or the like or may be directly disposed on the substrate 10, from the ink layer 11 side.

The ink layer 11 may be formed by, for example, directly drawing a pattern on the surface of the non-birefringent film 12 with an oil-based marker or by directly printing a pattern on the surface of the non-birefringent film 12 by a conventionally known method.

Examples of the non-birefringent film 12 include transparent films such as a triacetyl cellulose (TAG) film and an acrylic resin film. The non-birefringent film herein refers to a film having an in-plane retardation of 10 nm or smaller. For example, the TAG film has an in-plane retardation of 5 nm or smaller. The non-birefringent film 12 substantially does not alter the polarized state of incident polarized light.

When the integration of the ink layer 11 and the non-birefringent film 12 is bonded to the reflective polarizing plate 4 via a pressure-sensitive adhesive or the like, the surface (planar surface) of the non-birefringent film 12 opposite the ink layer 11 is bonded to the reflective polarizing plate 4. Bonding is thus not affected by the unevenness of the ink layer 11.

In contrast, when the integration of the ink layer 11 and the non-birefringent film 12 is bonded to the substrate 10 via a pressure-sensitive adhesive or the like, bonding is affected by the unevenness of the ink layer 11. However, for example, the use of a pressure-sensitive adhesive about four or more times thicker than the ink layer 11 enables bonding to be conducted without being affected by the unevenness of the ink layer 11. Since the ink layer 11 often has a thickness of 25 μm or smaller, bonding can be conducted without problems by using a pressure-sensitive adhesive having a thickness of, for example, about 100 μm.

### THIRD CONFIGURATION EXAMPLE

FIG. 4 is a schematic cross-sectional view of a third configuration example of the reflector. The third configuration example is the same as the second configuration example except for the order of arrangement of the ink layer and the non-birefringent film. Thus, duplicate explanations will be appropriately omitted. The reflector 2 includes, in the following order from the back surface side to the viewing surface side, the substrate 10 that does not depolarize incident polarized light, the non-birefringent film 12, and the ink layer 11. The ink layer 11 is in direct contact with the non-birefringent film 12. The integration of the ink layer 11 and the non-birefringent film 12 may be bonded to the substrate 10 via a pressure-sensitive adhesive or the like or may be directly disposed on the substrate 10, from the non-birefringent film 12 side.

When the integration of the ink layer 11 and the non-birefringent film 12 is bonded to the reflective polarizing plate 4 via a pressure-sensitive adhesive or the like, bonding is affected by the unevenness of the ink layer 11. However, for example, the use of a pressure-sensitive adhesive about four or more times thicker than the ink layer 11 enables bonding to be conducted without being affected by the unevenness of the ink layer 11. Since the ink layer 11 often has a thickness of 25 μm or smaller, bonding can be conducted without problems by using a pressure-sensitive adhesive having a thickness of, for example, about 100 μm.

In contrast, when the integration of the ink layer 11 and the non-birefringent film 12 is bonded to the substrate 10 via a pressure-sensitive adhesive or the like, the surface (planar surface) of the non-birefringent film 12 opposite the ink layer 11 is bonded to the substrate 10. Bonding is thus not affected by the unevenness of the ink layer 11.

### FOURTH CONFIGURATION EXAMPLE

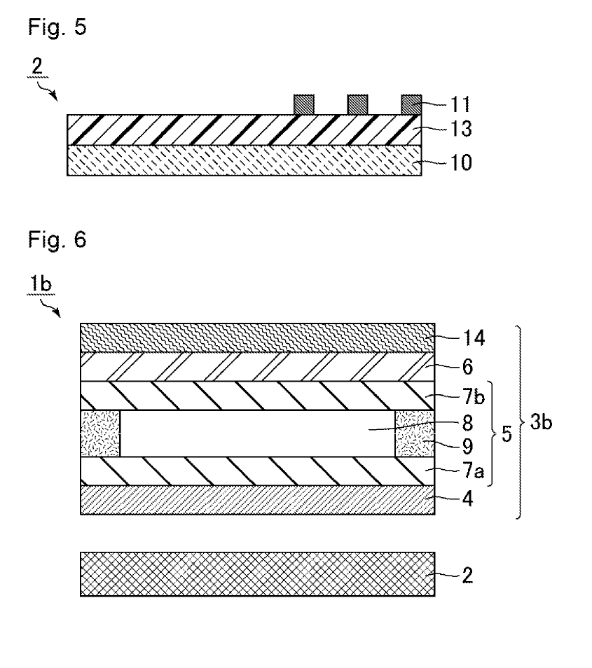

FIG. 5 is a schematic cross-sectional view of a fourth configuration example of the reflector. The reflector 2 include, in the following order from the back surface side to the viewing surface side, the substrate 10 that does not depolarize incident polarized light, a birefringent film 13, and the ink layer 11. The ink layer 11 is in direct contact with the birefringent film 13. The integration of the ink layer 11 and the birefringent film. 13 may be bonded to the substrate 10 via a pressure-sensitive adhesive or the like or may be directly disposed on the substrate 10, from the birefringent film 13 side.

The ink layer 11 may be formed by, for example, directly drawing a pattern on the surface of the birefringent film 13 with an oil-based marker or by directly printing a pattern on the surface of the birefringent film 13 by a conventionally known method.

Examples of the birefringent film 13 include transparent films such as a polyethylene terephthalate (PET) film. The birefringent film herein refers to a film having an in-plane retardation of greater than 10 nm. For example, many PET films have an in-plane retardation of 2000 nm or greater. The birefringent film 13 greatly alters the polarized state of incident polarized light. Thus, unlike in the third configuration example, the order of arrangement of the ink layer 11 and the birefringent film 13 cannot be changed. If the birefringent film 13 is positioned closer to the viewing surface side than the ink layer 11 is, the polarized state of the polarized light emerging from the switching mirror panel 3a is changed by birefringent film 13 before the polarized light reaches the ink layer 11.

When the integration of the ink layer 11 and the birefringent film 13 is bonded to the reflective polarizing plate 4 via a pressure-sensitive adhesive or the like, bonding is affected by the unevenness of the ink layer 11. However, for example, the use of a pressure-sensitive adhesive about four or more times thicker than the ink layer 11 enables bonding to be conducted without being affected by the unevenness of the ink layer 11. Since the ink layer 11 often has a thickness of 25 μm or smaller, bonding can be conducted without problems by using a pressure-sensitive adhesive having a thickness of, for example, about 100 μm.

In contrast, when the integration of the ink layer 11 and the birefringent film 13 is bonded to the substrate 10 via a pressure-sensitive adhesive or the like, the surface (planar surface) of the birefringent film 13 opposite the ink layer 11 is bonded to the substrate 10. Bonding is thus not affected by the unevenness of the ink layer 11.

Accordingly, the first to fourth configuration examples can sufficiently improve the visibility of the reflector 2 in the transparent mode.

From the viewpoint of sufficiently improving the visibility of the reflector 2 in the transparent mode, the transmittance in the transparent mode is preferably high. The transmittance in the transparent mode herein is defined by 100×R2/R1, where R1 is the reflectance of the reflector alone observed from, the viewing surface side, and R2 is the reflectance of the switching mirror device observed from the viewing surface side in the state where the switching mirror panel is in the transparent mode. The reflectance R1 and the reflectance R2 are specifically measured as follows. First, the reflectance R1 (unit: %) of the reflector 2 alone without the switching mirror panel 3a is measured from the viewing surface side. Next, the switching mirror panel 3a is disposed on the viewing surface side of the reflector 2 to prepare the switching mirror device 1a. Then, in the state where the switching mirror panel 3a is in the transparent mode, the reflectance R2 (unit: %) of the switching mirror device 1a is measured from the viewing surface side.

The transmittance (100* R2/R1) in the transparent mode is preferably 30% or higher and 100% or lower (i.e., preferably satisfies 30≤100×R2/R1≤100), more preferably higher than 39% and 100% or lower (i.e., more preferably satisfies 39<100×R2/R1≤100).

### Embodiment 2

FIG. 6 is a schematic cross-sectional view of a switching mirror panel and a switching mirror device of Embodiment 2. Embodiment 2 is the same as Embodiment 1 except that an anti-reflection film is disposed on the surface of the absorptive polarizing plate opposite the liquid crystal panel. Duplicate explanations thus will be appropriately omitted.

A switching mirror device 1b includes, in the following order from the back surface side to the viewing surface side, the reflector 2 and a switching mirror panel 3b.

The switching mirror panel 3b includes, in the following order from the back surface side to the viewing surface side, the reflective polarizing plate 4, the liquid crystal panel 5, the absorptive polarizing plate 6, and an anti-reflection film 14. The anti-reflection film 14 may be bonded to the surface of the absorptive polarizing plate 6 opposite the liquid crystal panel 5 via a pressure-sensitive adhesive or the like.

Examples of the anti-reflection film 14 include an anti-reflection film having on a surface thereof an uneven structure provided with projections at a pitch equal to or shorter than the wavelength of visible light, that is, a moth-eye structure. The moth-eye structure may be formed on the surface of the anti-reflection film 14 opposite the absorptive polarizing plate 6. The projections constituting the moth-eye structure may have any pitch that is equal to or shorter than the wavelength (780 nm) of visible light, and preferably have a pitch of 100 nm or longer and 500 nm or shorter. The projections may have any height, and preferably have a height of 100 nm or more and 300 nm or less. The projections may have any shape, and may have a conical shape, for example.

Examples of the anti-reflection film 14 other than the moth-eye anti-reflection film include anti-reflection films having on a surface thereof an anti-reflection layer made of an organic film (resin film) or an inorganic film. The anti-reflection layer may be formed on the surface of the anti-reflection film 14 opposite the absorptive polarizing plate 6.

Examples of the anti-reflection film 14 with an anti-reflection layer made of an organic film include an anti-reflection film (trade name: Fine Tiara (registered trademark)) available from Panasonic Corporation. The anti-reflection layer made of an organic film may include a low refractive index resin layer and a high refractive index resin layer stacked in the stated order from the back surface side to the viewing surface side, or may include many low refractive index resin layers and high refractive index resin layers stacked alternately. As the number of low refractive index resin layers and high refractive index resin layers stacked is increased, the reflectance decreases, so that the anti-reflection performance is improved; however, the cost increases correspondingly. The low refractive index resin layer may be one obtained by thinly applying a fluororesin such as a low refractive index material (trade name: OPSTAR (registered trademark)) available from JSR Corporation. The high refractive index resin layer may be one obtained by thinly applying a high refractive index coating solution available from Sumitomo Osaka Cement Co., Ltd.

In the case where the anti-reflection layer is made of an inorganic film, the anti-reflection film 14 may be an anti-reflection film available from Dexerials Corporation, for example. In such a case, the anti-reflection layer may include, for example, low refractive index films of silicon dioxide (SiO₂) and high refractive index films of niobium pentoxide (Nb₂O₅) that are alternately stacked.

The anti-reflection film 14 preferably has a reflectance of 0% or higher and 2% or lower, more preferably 0% or higher and 1% or lower. When the anti-reflection film 14 has a reflectance of 2% or lower, the reflectance on the surface of the switching mirror panel 3b opposite the reflector 2 is sufficiently low. Thus, the switching mirror panel 3b has a sufficiently improved transparency in the transparent mode.

In Embodiment 2, the anti-reflection film 14 is disposed on the surface of the absorptive polarizing plate 6 opposite the liquid crystal panel 5. This decreases reflectance on the surface of the switching mirror panel 3b opposite the reflector 2. As a result, the switching mirror panel 3b has a sufficiently improved transparency in the transparent mode, so that the reflector 2 in the transparent mode has a sufficiently improved visibility.

The present invention is described below in more detail based on examples and comparative examples. The examples, however, are not intended to limit the scope of the present invention.

### Example 1

A switching mirror device of Embodiment 1 was produced. The components of the switching mirror device of Example 1 are described below. In this example, the switching mirror panel 3a was directly disposed on the reflector 2.

The reflector 2 was the reflector according to the first configuration example (FIG. 2). The substrate 10 was a mirror obtained by depositing an aluminum layer onto the surface of a glass substrate. The ink layer 11 was formed by directly drawing a pattern on the surface of the substrate 10 with an oil-based marker.

The reflective polarizing plate 4 was a reflective polarizing plate (trade name: DBEF) available from 3M.

The liquid crystal panel 5 was a TN mode liquid crystal panel. The substrate 7a and the substrate 7b were each a substrate obtained by disposing an alignment film and a planar transparent electrode on a glass substrate.

The sealing material 9 was a sealing material prepared by dispersing micro glass beads (refractive index: 1.57) as spacers in a binder (refractive index: 1.57) made of a polyene-polythiol resin composition. The amount of the spacers in the sealing material 9 was 1% by weight. The sealing material 9 had a thickness of 5 μm and a haze of 2.5%. The haze was measured using a haze mater: (trade name: NDH2000) available from Nippon Denshoku Industries Co., Ltd.

The absorptive polarizing plate 6 was a plate obtained by adsorption alignment of an iodine complex on a PVA film. The absorptive polarizing plate 6 had a parallel transmittance of 36.6% and a contrast of 20000. The surface of the absorptive polarizing plate 6 opposite the liquid crystal panel 5 was not surface-treated, and had a reflectance of 4%.

The transmission axis of the reflective polarizing plate 4 and the transmission axis of the absorptive polarizing plate 6 were parallel to each other (the angle formed by the axes was 0°).

### Example 2

A switching mirror device was produced in the same manner as in Example 1 except that the type of the sealing material 9 was changed.

The sealing material 9 was a sealing material (refractive index: 1.51) containing an epoxy resin composition. The sealing material 9 had a thickness of 5 μm and a haze of 0.5%. In this example, no spacers were added to the sealing material 9. Instead, micro glass beads were spread in the liquid crystal layer 8 to maintain the cell gap in the liquid crystal panel 5.

### Example 3

A switching mirror device was produced in the same manner as in Example 2 except that spacers were added to the sealing material 9.

The sealing material 9 was a sealing material prepared by dispersing micro glass beads (refractive index: 1.57) as spacers in a binder (refractive index: 1.51) made of an epoxy resin composition. The amount of the spacers in the sealing material 9 was 0.3% by weight. The sealing material 9 had a thickness of 5 μm and a haze of 4%.

### Example 4

A switching mirror device was produced in the same manner as in Example 3 except that the amount of the spacers in the sealing material 9 was changed.

The sealing material 9 was a sealing material prepared by dispersing micro glass beads (refractive index: 1.57) as spacers in a binder (refractive index: 1.51) made of an epoxy resin composition. The amount of the spacers in the sealing material 9 was 0.6% by weight. The sealing material 9 had a thickness of 5 μm and a haze of 8%.

### Example 5

A switching mirror device was produced in the same manner as in Example 1 except that the type of the sealing material 9 was changed.

The sealing material 9 was glass frit. The sealing material 9 had a thickness of 5 μm and a haze of 0.5%.

### Example 6

A switching mirror device was produced in the same manner as in Example 1 except that the type of the reflector 2 was changed.

The reflector 2 was the reflector according to the second configuration example (FIG. 3). The substrate 10 was a mirror obtained by depositing an aluminum layer onto the surface of a glass substrate. The non-birefringent film 12 was a TAG film. The ink layer 11 was formed by directly drawing a pattern on the surface of the non-birefringent film 12 with an oil-based marker. In this example, the integration of the ink layer 11 and the non-birefringent film 12 was directly disposed on the substrate 10 from the ink layer 11 side.

### Example 7

A switching mirror device was produced in the same manner as in Example 1 except that the type of the reflector 2 was changed.

The reflector 2 was the reflector according to the third configuration example (FIG. 4). The substrate 10 was a mirror obtained by depositing an aluminum layer onto the surface of a glass substrate. The non-birefringent film 12 was a TAC; film. The ink layer 11 was formed by directly drawing a pattern on the surface of the non-birefringent film 12 with an oil-based marker. In this example, the integration of the ink layer 11 and the non-birefringent film 12 was directly disposed on the substrate 10 from the non-birefringent film 12 side.

### Example 8

A switching mirror device was produced in the same manner as in Example 1 except that the type of the reflector 2 was changed.

The reflector 2 was the reflector according to the fourth configuration example (FIG. 5). The substrate 10 was a mirror obtained by depositing an aluminum layer onto the surface of a glass substrate. The birefringent film 13 was a PET film. The ink layer 11 was formed by directly drawing a pattern on the surface of the birefringent film 13 with an oil-based marker. In this example, the integration of the ink layer 11 and the birefringent film 13 was directly disposed on the substrate 10 from the birefringent film 13 side.

### Example 9

A switching mirror device was produced in the same manner as in Example 1 except that the type of the reflector 2 was changed.

The reflector 2 was the reflector according to the first configuration example (FIG. 2). The substrate 10 was a glossy Inkjet paper (trade name: Photo Paper CRISPIA (registered trademark) (high gloss)) available from Seiko Epson Corporation. The ink layer 11 was formed by directly printing a pattern on the substrate 10 with an Inkjet printer.

### Example 10

A switching mirror device was produced in the same manner as in Example 1 except that the type of the reflector 2 was changed.

The reflector 2 was the reflector according to the first configuration example (FIG. 2). The substrate 10 was plain paper (trade name: Ink Jet Plain Paper) available from Seiko Epson Corporation. The ink layer 11 was formed by directly printing a pattern on the substrate 10 with an Inkjet printer.

### Example 11

A switching mirror device was produced in the same manner as in Example 1 except that the parallel transmittance of the absorptive polarizing plate 6 was changed.

The absorptive polarizing plate 6 was am absorptive polarizing plate having a parallel transmittance of 38.5% and a contrast of 10.

### Example 12

The switching mirror device of Embodiment 2 was produced. The components of the switching mirror device of Example 12 were the same as those used in Example 1 except for the anti-reflection film 14. In this example, the switching mirror panel 3b was directly disposed on the reflector 2.

The anti-reflection film 14 was an anti-reflection film having the moth-eye structure. The anti-reflection film 14 had a reflectance of 0.1%. The projections constituting the moth-eye structure had a pitch of 200 nm and a height of 200 nm.

### Example 13

A switching mirror device was produced in the same manner as in Example 12 except that the type of the sealing material 9 and the parallel transmittance of the absorptive polarizing plate 6 were changed.

The sealing material 9 was glass frit. The sealing material 9 had a thickness of 5 μm and a haze of 0.5%.

The absorptive polarizing plate 6 was an absorptive polarizing plate having a parallel transmittance of 38.5% and a contrast of 10.

### Comparative Example 1

A switching mirror device was produced in the same manner as in Example 3 except that the amount of the spacers in the sealing material 9 was changed.

The sealing material 9 was a sealing material prepared by dispersing micro glass beads (refractive index: 1.5) as spacers in a binder (refractive index: 1.51) made of an epoxy resin composition. The amount of the spacers in the sealing material 9 was 7% by weight. The sealing material 9 had a thickness of 5 μm and a haze of 63.8%.

### Comparative Example 2

A switching mirror device was produced in the same manner as in Example 3 except that the amount of the spacers in the sealing material 9 was changed.

The sealing material 9 was a sealing material prepared by dispersing micro glass beads (refractive index: 1.57) as spacers in a binder (refractive index: 1.51) made of an epoxy resin composition. The amount of the spacers in the sealing material 9 was 1.2% by weight. The sealing material 9 had a thickness of 5 μm and a haze of 12%.

### [Evaluation Results]

The switching mirror devices of Examples 1 to 13 and Comparative Examples 1 and 2 were subjected to visual evaluation of the sealing material and measurement of the transmittance in the transparent mode. The results are shown in Table 1.

### (Visual Evaluation of Sealing Material)

Twelve observes visually observed each switching mirror device from the viewing surface side to determine whether the sealing material was visible. The evaluation criteria were as follows. “Good”: Two thirds or more (eight or more observers) of all the observers were not able to see the sealing material. “Poor”: More than one third (five or more observers) of all the observers were able to see the sealing material.

### (Measurement of Transmittance in Transparent Mode)

The following measurement was conducted in each example and comparative example. First, the reflectance R1 (unit: %) of the reflector alone was measured from the viewing surface side. Next, the switching mirror panel was disposed on the viewing surface side of the reflector to produce a switching mirror device. Then, in the state where voltage was applied to the TN mode liquid crystal panel (the state where enough voltage was applied for optical rotation to be lost), in other words, in the state where the switching mirror panel was in the transparent mode, the reflectance R2 (unit: %) of the switching mirror device was measured from the viewing surface side. The transmittance in the transparent mode was then calculated from the reflectance R1 and the reflectance R2 according to the formula: Transmittance (%) in transparent mode =100× R2(%)/R1(%). The reflectance R1 and ref1ectance R2 were measured using a table-top spectrophotometer (trade name: CM-2600d, measurement wavelength range: 380 nm to 780 nm, integrating sphere type) available from Konica Minolta Japan, Inc. The reflection measurement mode was the specular component included (SCI) mode.

TABLE 1

| | Visual evaluation | Transmittance |
|---|---|---|
| | of sealing | in transparent |
| | material | mode (%) |
| Example 1 | Good | 43.5 |
| Example 2 | Good | 43.5 |
| Example 3 | Good | 43.5 |
| Example 4 | Good | 43.5 |
| Example 5 | Good | 43.5 |
| Example 6 | Good | 39.8 |
| Example 7 | Good | 39.8 |
| Example 8 | Good | 39.6 |
| Example 9 | Good | 37.1 |
| Example 10 | Good | 35.1 |
| Example 11 | Good | 45.5 |
| Example 12 | Good | 44.8 |
| Example 13 | Good | 46.6 |
| Comparative | Poor | 35.1 |
| Example 1 | | |
| Comparative | Poor | 43.5 |
| Example 2 | | |

Table 1 shows that the sealing material was not visible in any of Examples 1 to 13 and excellent design characteristics were achieved in these examples. In addition, in all of Examples 1 to 13, the transmittance in the transparent mode was 30% or higher and the visibility of the reflector in the transparent mode was excellent. Among Examples 1 to 13, Examples 6 to 8 were better, Examples 1 to 5, 11, and 12 were still better, and Example 13 is particularly excellent, in the visibility of the reflector in the transparent mode. In contrast, in Comparative Examples 1 and 2, as shown in Table 1, the sealing material was visible and the design characteristics were inferior.

### [Additional Remarks]

Examples of preferable characteristics of the switching mirror panel of the present invention are listed below. The examples may be appropriately combined within the spirit of the present invention.

The sealing material may contain a binder and spacers dispersed in the binder, and the difference in refractive index between the binder and the spacers may be 0 or greater and 0.05 or smaller. Based on this condition, the sealing material has a high transparency and thus is less visible.

The sealing material may contain no spacers. Based on this condition, the sealing material has a high transparency and thus is less visible.

The sealing material may contain glass frit. Based on this condition, the sealing material has a high transparency and thus is less visible.

The absorptive polarizing plate may have a parallel transmittance of 37% or higher and 50% or lower. Based on this condition, the switching mirror panel has a sufficiently improved transparency in the transparent mode.

The switching mirror panel may further include an anti-reflection film on the surface of the absorptive polarizing plate opposite the liquid crystal panel. Based on this condition, the switching mirror panel has a sufficiently improved transparency in the transparent mode.

Examples of preferable characteristics of the switching mirror device of the present invention are listed below. The examples may be appropriately combined within the spirit of the present invention.

The reflector may include a substrate that does not alter the polarization state of incident polarized light. Based on this condition, the reflector has a sufficiently improved visibility in the transparent mode.

The reflector may include, in the following order from the back surface side to the viewing surface side, the substrate and an ink layer in direct contact with the substrate. Based on this condition, the reflector has a sufficiently improved visibility in the transparent mode.

The reflector may include, in the following order from the back surface side to the viewing surface side, the substrate, an ink layer, and a non-birefringent film in direct contact with the ink layer. Based on this condition, the reflector has a sufficiently improved visibility in the transparent mode.

The reflector may include, in the following order from the back surface side to the viewing surface side, the substrate, a non-birefringent film, and an ink layer in direct contact with the non-birefringent film. Based on this condition, the reflector has a sufficiently improved visibility in the transparent mode.

The reflector may include, in the following order from the back surface side to the viewing surface side, the substrate, a birefringent film, and an ink layer in direct contact with the birefringent film. Based on this condition, the reflector has a sufficiently improved visibility in the transparent mode.

The switching mirror device may satisfy 30≤100× R2/R1≤100, or may satisfy 39<100× R2/R1≤100× where R1 is a reflectance of the reflector alone observed from the viewing surface side, and R2 is a reflectance of the switching mirror device observed from, the viewing surface side in the state where the switching mirror panel is in the transparent mode. Based on this condition, the reflector has a sufficiently improved visibility in the transparent mode.

### REFERENCE SIGNS LIST

1a, 1b: Switching mirror device
2: Reflector
3a, 3b : Switching mirror panel
4: Reflective polarizing plate
5: Liquid crystal panel
6: Absorptive polarizing plate
7a, 7b : Substrate
8: Liquid crystal layer
9: Sealing material
10: Substrate
11: Ink layer
12: Non-birefringent film
13: Birefringent film
14 : Anti-reflection film

1. A switching mirror panel comprising, in the following order from the back surface side to the viewing surface side:
a reflective polarizing plate;
a liquid crystal panel including paired facing substrates, and a liquid crystal layer and a sealing material disposed between the paired substrates; and
an absorptive polarizing plate,
wherein the switching mirror panel is capable of switching between a transparent mode and a mirror mode, where the transparent mode allows light to pass from the viewing surface side of the absorptive polarizing plate to the back surface side of the reflective polarizing plate and the mirror mode does not allow light to pass from the viewing surface side of the absorptive polarizing plate to the back surface side of the reflective polarizing plate,
the sealing material transmits light incident from the normal direction of the absorptive polarizing plate, and
the sealing material has a haze of 0% or higher and 10% or lower.

2. The switching mirror panel according to claim 1,
wherein the sealing material contains a binder and spacers dispersed in the binder, and
the difference in refractive index between the binder and the spacers is 0 or greater and 0.05 or smaller.

3. The switching mirror panel according to claim 1,
wherein the sealing material contains no spacers.

4. The switching mirror panel according to claim 1,
wherein the sealing material contains glass frit.

5. The switching mirror panel according to claim 1,
wherein the absorptive polarizing plate has a parallel transmittance of 37% or higher and 50% or lower,

6. The switching mirror panel according to claim 1, further comprising
an anti-reflection film on the surface of the absorptive polarizing plate opposite the liquid crystal panel.

7. A switching mirror device, comprising, in the following order from the back surface side to the viewing surface side:
a reflector that is a non-self-luminous body; and
the switching mirror panel according to claim 1.

8. The switching mirror device according to claim 7,
wherein the reflector includes a substrate that does not alter the polarization state of incident polarized light.

9. The switching mirror device according to claim 8,
wherein the reflector includes, in the following order from the back surface side to the viewing surface side,
the substrate and
an ink layer in direct contact with the substrate.

10. The switching mirror device according to claim 8,
wherein the reflector includes, in the following order from the back surface side to the viewing surface side,
the substrate,
an ink layer, and
a non-birefringent film in direct contact with the ink layer.

11. The switching mirror device according to claim 8,
wherein the reflector includes, in the following order from the back surface side to the viewing surface side,
the substrate,
a non-birefringent film, and
an ink layer in direct contact with the non-birefringent film.

12. The switching mirror device according to claim 8,
wherein the reflector includes, in the following order from the back surface side to the viewing surface side,
the substrate,
a birefringent film, and
an ink layer in direct contact with the birefringent film.

13. The switching mirror device according to claim 7, which satisfies 30≤100× R2/R1≤100, where R1 is a reflectance of the reflector alone observed from the viewing surface side, and R2 is a reflectance of the switching mirror device observed from the viewing surface side in the state where the switching mirror panel is in the transparent mode.

14.) The switching mirror device according to claim 13, which satisfies 39<100× R2/R1≤100.
